(19) United States
(12) Patent Application Publication
(10) Pub. No.: US 2015/0068416 A1
(43) Pub. Date: Mar. 12, 2015

(54) LOW PROFILE LAMINATE ASSEMBLIES

(71) Applicant: Hamilton Sundstrand Space Systems International, Inc., Windsor Locks, CT (US)

(72) Inventor: Jorge E. Hidalgo, Suffield, CT (US)

(73) Assignee: Hamilton Sundstrand Space Systems International, Inc., Windsor Locks, CT (US)

(21) Appl. No.: 14/173,139

(22) Filed: Feb. 5, 2014

Related U.S. Application Data
(60) Provisional application No. 61/876,277, filed on Sep. 11, 2013.

(51) Int. Cl. B30B 15/04

(52) U.S. Cl. CPC B30B 15/04
USPC 100/265

(57) ABSTRACT

An assembly has a plurality of laminate components aligned atop each other. A first endplate is at one end of the assembly of components and a second endplate is at an opposed end. The first and second endplates have outer surfaces facing away from the components. A spring force applies a compressive force to bias the first and second endplates together and, in turn, apply a force across the laminate components. The spring force is provided by a spring mounted between the outer surfaces of the first and second endplates.

### RELATED APPLICATION

This application claims priority to U.S. Provisional Application No. 61/876,277, filed Sep. 11, 2013.

### STATEMENT REGARDING FEDERALLY SPONSORED RESEARCH OR DEVELOPMENT

This invention was made with government support under Contract No. N00014-12-D-0372-0001, awarded by the United States Navy. The Government has certain rights in this invention.

### BACKGROUND

This application relates to an assembly of a plurality of laminate components, wherein a compression element is provided between outer ends of endplates for the assembly.

Laminate assemblies are utilized in a number of applications. As one example, a plurality of fuel cells may be mounted on a vehicle and stacked atop each other as a laminate assembly. Typically, endplates are placed at outer ends of the assembly.

It is important to maintain compression across the assembly and, thus, it is known to have bolts or other securement members mount Belleville washers at a location outwardly of one of the endplates.

The overall height of the assembly is, thus, increased, in that the Belleville washers and associated mount structures are positioned beyond an outer end of the endplates.

### SUMMARY

An assembly has a plurality of laminate components aligned atop each other. A first endplate is at one end of the assembly of components and a second endplate is at an opposed end. The first and second endplates have outer surfaces facing away from the components. A spring force applies a compressive force to bias the first and second endplates together and, in turn, apply a force across the laminate components. The spring force is provided by a spring mounted between the outer surfaces of the first and second endplates.

These and other features may be best understood from the following drawings and specification.

### BRIEF DESCRIPTION OF THE DRAWINGS

FIG. 1 shows a first embodiment.

FIG. 2 shows a second embodiment.

### DETAILED DESCRIPTION

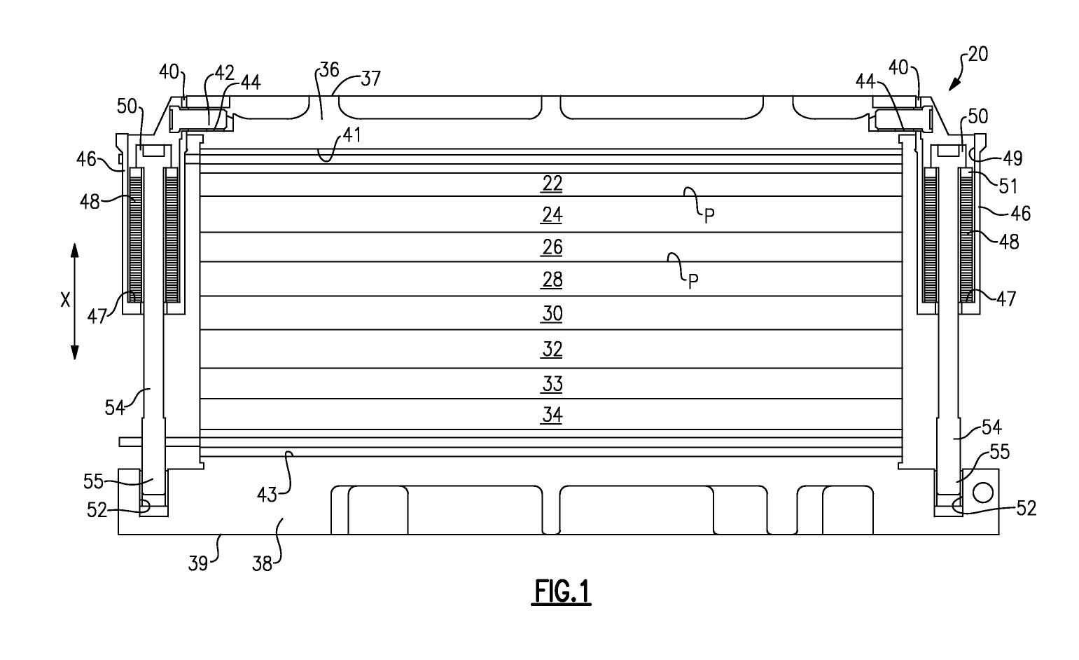

FIG. 1 shows an assembly 20 including a plurality of laminate components 22, 24, 26, 28, 30, 32, 33, 34, etc.

Endplates 36 and 38 are mounted at ends of the laminate assembly. Endplate 36 has an outer surface 37 and endplate 38 has an outer surface 39. Endplate 36 has an inner surface 41 facing the laminate components 22-34 and endplate 38 has an inner surface 43 also facing the components.

The laminate components 22-34 are generally planar and have a large cross-sectional face P. The components 22-34 are stacked with their planar surfaces P atop and in contact with each other. An axial distance X can be defined perpendicular to the planar surface.

In applications, the laminate components may be fuel cells. One application for the assembly 20 would be on unmanned vehicles, such as a space, or underwater, vehicle. Alternatively, they could be electrolyzers, such as utilized to provide oxygen. Further, they could be a plurality of heat exchanger cores. Other generally planar components can also benefit from these teachings.

It is important to maintain compression across the assembly 20 and, thus, Belleville washers 48 apply a tension force drawing the endplates 36 and 38 together to maintain a compression bias across the stack of components 22-34.

The Belleville washers 48 are mounted within a barrel 46. As shown, the Belleville washers are intermediate, or between, the surfaces 41 and 43. More generally, they are axially intermediate, or between, the surfaces 37 and 39.

The barrel 46 has a flange 40 extending over a limited circumferential range and bolted at 42 to the endplate 36. Bolt 42 extends into a hole 44. Of course, other ways to secure the barrel 46 to endplate 36 may be used.

It should be understood that a plurality of the barrels 46 may be spaced about the assembly 20. A long bolt 54 has a head 50 abutting a washer 51 at one end of the Belleville washers 48 and applying a compressive force on the Belleville washers 48 against an inner lip 47 of the barrel 46. A threaded end 55 of the long fastener 54 is threaded into a blind hole 52 in the opposed endplate 38.

When the assembly 20 is assembled, the bolts 50 may be tightened through the Belleville washers 48 and into the threads in the blind hole 52. In this manner, the compressive force is maintained on the assembled components 22-34.

As known, the Belleville washers 48 maintain a compressive force which is able to compensate for creep or other adjustment in the size of the components 22-34 over time.

By providing the Belleville washers 48 between the surfaces 41 and 43, the overall height of the assembly 20 is reduced compared to the prior art.

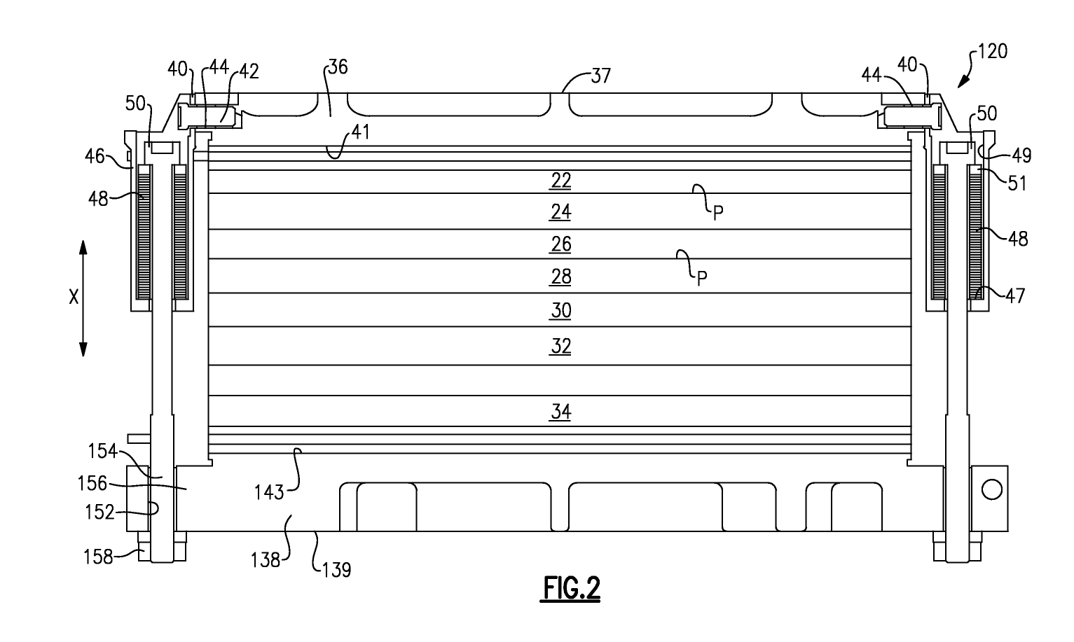

As shown in FIG. 2 in another embodiment 120, the long fasteners 154 extend through a hole 152 in the end plate 38 and receive a washer 156 and nut 158. This embodiment may require a compressive jig to apply compression as the nuts 158 are tightened on the long fasteners 154.

The laminate components 22-34 are generally planar and have a large cross-sectional face P. The components 22-34 are stacked with their planar surfaces P atop and in contact with each other. An axial distance X can be defined perpendicular to the planar surface.

Endplates 36 and 138 are mounted at ends of the laminate assembly. Endplate 36 has an outer surface 37 and endplate 138 has an outer surface 139. Endplate 36 has an inner surface 41 facing the laminate components 22-34 and endplate 138 has an inner surface 143 also facing the components.

In applications, the laminate components may again be fuel cells. One application for the assembly 120 would be on unmanned vehicles, such as a space, or underwater, vehicle. Alternatively, they could also be electrolyzers, such as utilized to provide oxygen, or a plurality of heat exchanger cores. Other generally planar component can also benefit from these teachings.

It is again important to maintain compression across the assembly 120 and, thus, Belleville washers 48 apply a tension force drawing the endplates 36 and 138 together to maintain a compression bias across the stack of components 22-34.

The Belleville washers 48 are mounted within a barrel 46, are intermediate, or between, the surfaces 41 and 143. More generally, they are axially intermediate, or between, the surfaces 37 and 139.

While Belleville washers 48 are disclosed, other types of springs and biasing devices may be utilized to provide a spring force. Examples may be wave washers or other compression springs. Helical springs or bellows springs could also be used. This list is not intended to be exhaustive.

Although an embodiment of this invention has been disclosed, a worker of ordinary skill in this art would recognize that certain modifications would come within the scope of this disclosure. For that reason, the following claims should be studied to determine the true scope and content of this disclosure.

1. An assembly comprising:
a plurality of laminate components aligned atop each other;
a first endplate at one end of said assembly of components and a second endplate at an opposed end, each of said first and second endplates having outer surfaces facing away from said components;
a spring force to bias said first and second endplates together and, in turn, apply a force across the laminate components; and
said spring force being provided by a spring mounted between said outer surfaces of said first and second endplates.

2. The assembly as set forth in claim 1, wherein said endplates have an inner surface facing said assembly of laminate components and said spring being between said inner surfaces of said first and second endplates.

3. The assembly as set forth in claim 1, wherein said spring is a Belleville washer stack.

4. The assembly as set forth in claim 1, wherein said spring is provided within a barrel, said barrel extending alongside said plurality of components.

5. The assembly as set forth in claim 4, wherein said spring provides an adjustable force relative to said first and second endplates.

6. The assembly as set forth in claim 5, wherein a threaded fastener secures said spring within said barrel and applies an adjustable force by being tightened through a nut and against a bottom lip of said barrel.

7. The assembly as set forth in claim 4, wherein said barrel has a flange which is secured to one of said endplates and said fastener being secured to a second of said endplates.

8. The assembly as set forth in claim 7, wherein said fastener is tightened within a blind hole in said second of said endplates.

9. The assembly as set forth in claim 7, wherein said threaded fastener extends through a hole in said second of said endplates and is secured by a nut beyond said outer surface of said second endplate.

10. The assembly as set forth in claim 4, wherein said spring is a Belleville washer stack.

11. The assembly as set forth in claim 1, wherein said components define generally planar surfaces, and an axial distance is defined perpendicular to said planar surfaces, with said spring being mounted axially between said surfaces of said first and second endplates.

12. An assembly comprising:
a plurality of laminate components aligned atop each other;
a first endplate at one end of said assembly of components and a second endplate at an opposed end, each of said first and second endplates having outer surfaces facing away from said components;
a spring force to bias said first and second endplates together and, in turn, apply a force across the laminate components; and
said components being generally planar, and an axial distance being defined perpendicular to said planar surface, with said spring force being provided by a spring mounted axially between said outer surfaces of said first and second endplates, said spring being a Belleville washer stack mounted within a barrel, said barrel extending alongside said plurality of components, a threaded fastener securing said spring within said barrel and providing an adjustable force by being tightened relative to said first and second endplates, said threaded fastener applying a force to said spring through a nut and against a bottom lip of said barrel, and said barrel having a flange which is secured to one of said endplates and said fastener being secured to a second of said endplates.

13. The assembly as set forth in claim 12, wherein said endplates have an inner surface facing said assembly of laminate components and said spring being positioned axially between said inner surfaces of said first and second endplates.

14. The assembly as set forth in claim 12, wherein said fastener is tightened within a blind hole in said second of said endplates.

15. The assembly as set forth in claim 12, wherein said threaded fastener extends through a hole in said second of said endplates and is secured by a nut.
